(19) United States
(12) Patent Application Publication
(10) Pub. No.: US 2024/0212268 A1
(43) Pub. Date: Jun. 27, 2024

(54) INFORMATION PROCESSING APPARATUS, INFORMATION PROCESSING METHOD, AND RECORDING MEDIUM

(71) Applicant: SONY GROUP CORPORATION, TOKYO (JP)

(72) Inventor: TAIHEI MENO, TOKYO (JP)

(21) Appl. No.: 18/556,363

(22) PCT Filed: Jan. 12, 2022
(86) PCT No.: PCT/JP2022/000675

§ 371 Date: Oct. 20, 2023

(30) Foreign Application Priority Data
May 11, 2021 (JP) 2021-080232

(51) Int. Cl. G06T 17/00; G06T 7/70; H04N 13/279; H04N 13/359

(52) U.S. Cl. CPC G06T 17/00; G06T 7/70; H04N 13/279; H04N 13/359

(57) ABSTRACT

An information processing apparatus according to one embodiment of the present technology includes a display controller. The display controller switches a display format of a virtual object on the basis of viewpoint information of a user who visually recognizes a virtual space and position information of the virtual object displayed within the virtual space. This makes it possible to achieve a high-quality viewing experience. Further, it is possible to maintain a space within the virtual space and also eliminate limitations in creating content including the virtual object.

### TECHNICAL FIELD

The present technology relates to an information processing apparatus, an information processing method, and a recording medium that are applicable to image display.

### BACKGROUND ART

Patent Literature 1 describes an information processing apparatus that displays a stereoscopic image, in a region corresponding to a distance from a lower end to an upper end of a display surface, on which a display unit displays a stereoscopic image, and to an angle formed by a horizontal plane in real space and the display surface, such that a first plane parallel to the horizontal plane is observed. This is designed to suppress a burden on a user who observes the stereoscopic image (paragraphs [0025] to [0057] of the specification, FIG. 4, and the like of Patent Literature 1).

### CITATION LIST

### Patent Literature

Patent Literature 1: WO 2018/116580

### DISCLOSURE OF INVENTION

### Technical Problem

There is a demand for a technology capable of providing a high-quality viewing experience in such a device that displays a stereoscopic image.

In view of the circumstances as described above, it is an object of the present technology to provide an information processing apparatus, an information processing method, and a recording medium that are capable of providing a high-quality viewing experience.

### Solution to Problem

In order to achieve the above object, an information processing apparatus according to an embodiment of the present technology includes a display controller.

The display controller switches a display format of a virtual object on the basis of viewpoint information of a user who visually recognizes a virtual space and position information of the virtual object displayed within the virtual space.

In such an information processing apparatus, the display format of the virtual object is switched on the basis of the viewpoint information of the user who visually recognizes the virtual space and the position information of the virtual object displayed within the virtual space. This makes it possible to provide a high-quality viewing experience.

The virtual space may include a first region and a second region. In this case, the display controller may switch the display format of the virtual object displayed in the first region.

The information processing apparatus may further include a determination unit that determines whether or not the virtual object is a target of the switching of the display format.

The determination unit may determine whether or not the virtual object exists in the first region on the basis of the position information, and if the virtual object exists in the first region, may set the virtual object as the target of the switching of the display format.

The determination unit may determine whether or not the virtual object traverses a boundary of the first region on the basis of the position information, and if the virtual object traverses the first region, may set the virtual object as the target of the switching of the display format.

The determination unit may determine whether or not the viewpoint information in the virtual object existing in the first region is changed on the basis of the viewpoint information, and if the viewpoint information is changed, may set the virtual object as the target of the switching of the display format.

The determination unit may determine whether or not the position information of the virtual object existing in the first region is changed on the basis of the position information, and if the position information is changed, may set the virtual object as the target of the switching of the display format.

The determination unit may determine whether or not the virtual object existing in the first region exists within a field of view of the user on the basis of the viewpoint information and the position information, and if the virtual object exists in the field of view of the user, may set the virtual object as the target of the switching of the display format.

The information processing apparatus may further include a calculation unit that calculates a parallax of the user with respect to the virtual object set as the target of the switching of the display format.

The display controller may switch the display format of the virtual object set as the target of the switching of the display format on the basis of a calculation result by the calculation unit.

The virtual object may include a stereoscopic image and a planar image. In this case, the switching of the display format may include at least one of switching of the virtual object from the stereoscopic image to the planar image or switching of the virtual object from the planar image to the stereoscopic image.

If an amount of change in parallax of the user with respect to the virtual object of the stereoscopic image exceeds a threshold, the virtual object being set as the target of the switching of the display format, the display controller may switch the virtual object set as the target of the switching of the display format from the stereoscopic image to the planar image.

If an amount of change in parallax of the user with respect to the virtual object of the planar image exceeds a threshold, the virtual object being set as the target of the switching of the display format, the display controller may maintain the display format of the virtual object set as the target of the switching of the display format.

If an amount of change in parallax of the user with respect to the virtual object of the planar image does not exceed a threshold, the virtual object being set as the target of the switching of the display format, the display controller may switch the virtual object set as the target of the switching of the display format from the planar image to the stereoscopic image.

If an amount of change in parallax of the user with respect to the virtual object of the stereoscopic image does not exceed a threshold, the virtual object being set as the target of the switching of the display format, the display controller may maintain the display format of the virtual object set as the target of the switching of the display format.

The determination unit may determine whether or not an amount of change in parallax of the user with respect to the virtual object exceeds a threshold within a predetermined time, and if the amount of change in parallax of the user exceeds the threshold within the predetermined time, may set the virtual object as the target of the switching of the display format. An information processing method according to an embodiment of the present technology is an information processing method executed by a computer system, the method including switching a display format of a virtual object on the basis of viewpoint information of a user who visually recognizes a virtual space and position information of the virtual object displayed within the virtual space.

A recording medium according to an embodiment of the present technology is a recording medium, on which a program is described, the program causing a computer system to execute the following step of switching a display format of a virtual object on the basis of viewpoint information of a user who visually recognizes a virtual space and position information of the virtual object displayed within the virtual space.

### BRIEF DESCRIPTION OF DRAWINGS

FIG. 1 is a diagram schematically showing an image display system according to a first embodiment of the present technology.

FIG. 2 is a schematic diagram showing a virtual space.

FIG. 3 is a schematic diagram showing a display example of a virtual object subjected to display-format switching.

FIG. 4 is a block diagram showing a configuration example of an information processing apparatus.

FIG. 5 is a flowchart showing the display-format switching.

FIG. 6 is a schematic diagram showing a case where a virtual object traverses a display region.

FIG. 7 is a schematic diagram showing a case where a position of a user's viewpoint is changed.

FIG. 8 is a schematic diagram showing a case where a position of the virtual object is changed.

FIG. 9 is a schematic diagram showing a case of a plurality of parallax calculation targets.

FIG. 10 is a schematic diagram showing a case where the position of the user's viewpoint is changed.

FIG. 11 is a schematic diagram showing a case where the position of the user's viewpoint is changed.

FIG. 12 is a flowchart of display-format switching in a fully-immersive head mounted display and a video see-through head mounted display.

FIG. 13 is a schematic diagram showing a 2D display method for a virtual object in the fully-immersive head mounted display and the video see-through head mounted display.

### MODE (S) FOR CARRYING OUT THE INVENTION

Hereinafter, embodiments according to the present technology will be described with reference to the drawings.

### FIRST EMBODIMENT

### [Configuration of Image Display System]

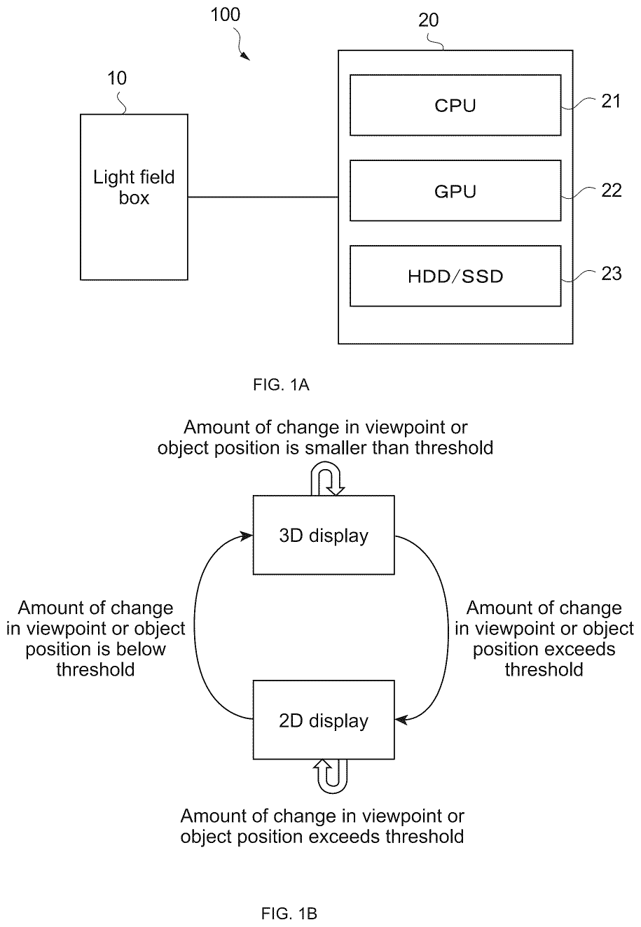

FIG. 1 schematically shows an image display system according to a first embodiment of the present technology. A of FIG. 1 is a schematic diagram showing an environment configuration in which the image display system is implemented. B of FIG. 1 is a display transition diagram of a virtual object.

As shown in A of FIG. 1, an image display system 100 includes a glasses-free stereoscopic display (glasses-free stereoscopic image display apparatus) 10 and an information processing apparatus 20.

The glasses-free stereoscopic display 10 is an image display apparatus capable of displaying a planar image and a stereoscopic image in a virtual space.

For example, the glasses-free stereoscopic display 10 includes a display unit, a user detection unit (not shown), and the like.

For example, the display unit is a display that displays a planar image and a stereoscopic image.

For example, the user detection unit detects viewpoint information of a user who visually recognizes a virtual space. The viewpoint information includes a position of a left eye and a position of a right eye of the user. In addition to that information, a line of sight direction of the left eye, a line of sight direction of the right eye, a user's field of view, a user's posture and face, and the like may be detected as the viewpoint information.

Further, an acceleration sensor, a gyro sensor, a magnetic sensor, or the like for detecting a posture of a display serving as the display unit may be mounted. Further, the user detection unit may be constituted by a camera, a depth camera, a motion sensor, or the like, or may be implemented by a configuration capable of tracking a user.

The information processing apparatus 20 includes a CPU 21, a GPU 22, and an HDD or an SSD 23. In addition to this, the information processing apparatus 20 includes hardware necessary for the configuration of a computer, for example, a processor such as a DSP, memories such as a ROM and a RAM, and a storage device. For example, the CPU loads a program according to the present technology, which is recorded in advance on the ROM or the like, to the RAM and executes the program, so that an information processing method according to the present technology is executed.

For example, it is possible to achieve the information processing apparatus 20 by any computer such as a PC. As a matter of course, hardware such as a FPGA or an ASIC may be used.

In this embodiment, the CPU executes a predetermined program, thus configuring a display controller as a functional block. As a matter of course, in order to implement a functional block, dedicated hardware such as an integrated circuit (IC) may be used.

The program is installed on the information processing apparatus 20, for example, via various recording media. Alternatively, the program may be installed via the Internet or the like.

The type or the like of recording media on which programs are recorded is not limited, and any computer-readable recording media may be used. For example, any non-transitory computer-readable recording media may be used.

The information processing apparatus 20 switches a display format of a virtual object on the basis of the viewpoint information of the user and position information of a virtual object displayed in a virtual space. In this embodiment, the virtual object includes a stereoscopic image and a planar image. In other words, display-format switching includes switching from 3D display to 2D display of a virtual object, and switching from 2D display to 3D display of a virtual object.

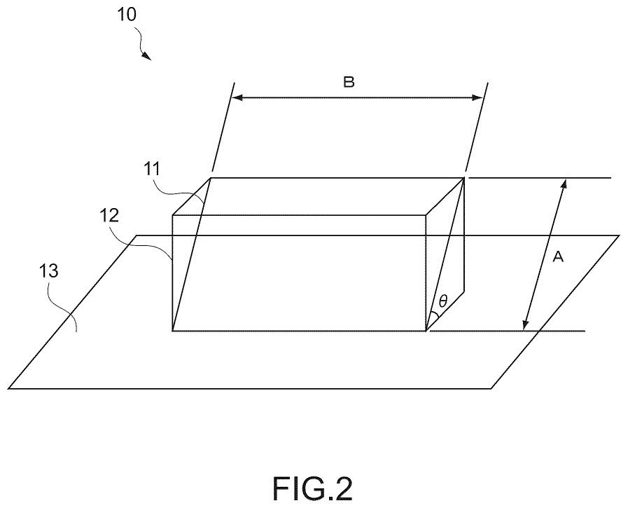

The virtual space is a space displayed by the display unit capable of displaying a stereoscopic image and a planar image. In this embodiment, the virtual space is divided into the inside of a display region and the outside of the display region. Typically, the display region is set according to the size of the display unit of the glasses-free stereoscopic display 10. In other words, the display region is set according to the size or angle of the display (see FIG. 2). Note that the size (range) of the inside of the display region and the outside of the display region may be set discretionarily. For example, the display region may be set according to content to be displayed by the glasses-free stereoscopic display 10.

In this embodiment, the information processing apparatus 20 switches the display format of a virtual object displayed on the outside of the display region. As shown in B of FIG. 1, when the amount of change in position of a user's viewpoint with respect to a 3D-displayed virtual object or of the virtual object exceeds a threshold, the information processing apparatus 20 changes the 3D-displayed virtual object into a 2D-displayed virtual object. Further, when the amount of change in position of a user's viewpoint with respect to a 3D-displayed virtual object or of the virtual object is smaller than a threshold, the information processing apparatus 20 maintains the 3D display.

Similarly, when the amount of change in position of a user's viewpoint with respect to a 2D-displayed virtual object or of the virtual object is below a threshold, the information processing apparatus 20 changes the 2D-displayed virtual object into a 3D-displayed virtual object. Further, when the amount of change in position of a user's viewpoint with respect to a 2D-displayed virtual object or of the virtual object exceeds a threshold, the information processing apparatus 20 maintains the 2D display.

FIG. 2 is a schematic diagram showing the virtual space.

As shown in FIG. 2, an inside of a display region 12 and an outside of a display region 13, which are displayed by a display surface 11 of the glasses-free stereoscopic display 10, are illustrated.

In this embodiment, the inside of the display region 12 is set according to the size of the display surface 11. In other words, in FIG. 2, the volume of the inside of the display region 12 is set by a short side A of the display surface 11×sinθ, the short side A×cosθ, and a long side B of the display surface 11.

Further, the outside of the display region 13 is a range excluding the inside of the display region 12 within the virtual space.

In the case of the glasses-free stereoscopic display 10 as shown in FIG. 2, since the user takes a viewing posture for viewing the display surface 11 from a higher point of view, a space matched with the size of the display (the inside of the display region 12) is defined, so that a stereoscopic effect is increased. However, if the virtual object is displayed outside the space (the outside of the display region 13), the inside of the display region 12 is not recognized, and the stereoscopic effect is degraded. In other words, content production is limited.

Further, in the case of the glasses-free stereoscopic display 10, when a plurality of virtual objects is disposed in the depth direction (direction of short side A×cosθ) and if the virtual objects with a large parallax are displayed instantaneously (e.g., 1 fps) on the far side, fusion is difficult to occur and the virtual objects appear to be displayed doubly, which causes motion sickness of the user.

In the present invention, display-format switching from 3D display to 2D display and from 2D display to 3D display is dynamically performed on the basis of the position of the user's viewpoint and the movement of the virtual object. This makes it possible to maintain the space on the inside of the display region 12 and eliminate limitations in the content production.

Further, in the present invention, if there is a virtual object displayed on the outside of the display region 13 and exceeding a threshold of a parallax, the virtual object is rendered as a 2D image matched with the position of the user's viewpoint on the outside of the display region 13, and is used as a background texture for the inside of the display region 12 to be displayed like a diorama background. This makes it possible to prevent a user's viewing experience from being impaired.

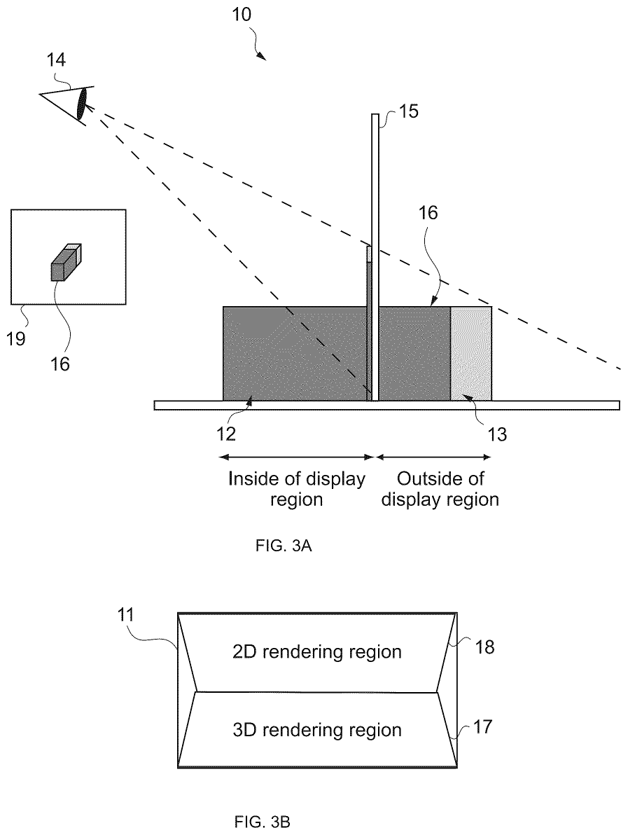

FIG. 3 is a schematic diagram showing a display example of a virtual object subjected to display-format switching. A of FIG. 3 is a schematic diagram of a case where the glasses-free stereoscopic display 10 and the virtual space are viewed from a long-side direction of the display surface 11. B of FIG. 3 is a schematic diagram showing 2D and 3D rendering positions.

As shown in A of FIG. 3, a user 14 views the glasses-free stereoscopic display 10 and the virtual space from a higher point of view. In A of FIG. 3, the near side of the user 14 is the inside of the display region 12, and the far side from a wall surface 15 of the glasses-free stereoscopic display 10 is the outside of the display region 13. Further, in A of FIG. 3, the case where a virtual object 16 traverses the wall surface 15 (boundary of the inside of the display region 12) is illustrated.

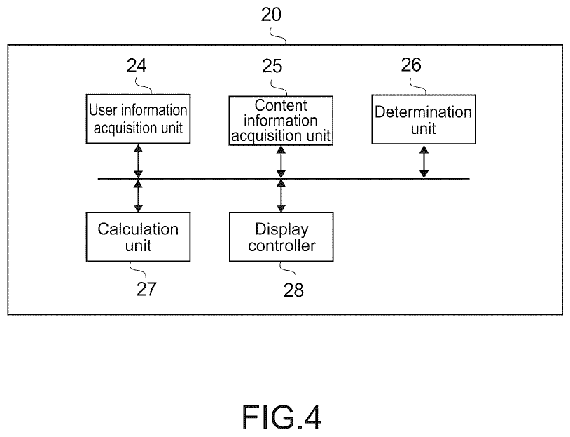

At that time, it is assumed that the amount of change in parallax of the user 14 with respect to the virtual object 16 traversing the boundary of the inside of the display region 12 exceeds a threshold. In this case, a display controller 28, which will be described later with reference to FIG. 4, projects the virtual object 16 located on the outside of the display region 13 onto the wall surface 15 of the glasses-free stereoscopic display 10, two-dimensionally and in real time as shown in B of FIG. 3, in accordance with the viewpoint of the user 14. In other words, the user 14 can visually recognize a screen in which the virtual objects 16 displayed in a 3D rendering region 17 and a 2D rendering region 18 are fused without causing a feeling of strangeness between 3D display and 2D display, like an overhead view 19.

In such a manner, if the display format of the virtual object is switched in accordance with the parallax in real time, and a 2D-displayed background image following the viewpoint position is generated, a high-quality viewing experience can be achieved.

FIG. 4 is a block diagram showing a configuration example of the information processing apparatus shown in FIG. 1.

As shown in FIG. 4, the information processing apparatus 20 includes a user information acquisition unit 24, a content information acquisition unit 25, a determination unit 26, a calculation unit 27, and a display controller 28.

The user information acquisition unit 24 acquires information regarding a user who visually recognizes a virtual space. In this embodiment, the user information acquisition unit 24 acquires user's viewpoint information from user's image information acquired by the user detection unit (e.g., camera) mounted on the glasses-free stereoscopic display 10.

The viewpoint information such as the position of the eye, the line of sight, the field of view, and the like acquired by the user information acquisition unit 24 is supplied to the determination unit 26 and the calculation unit 27.

Note that, in this embodiment, the position of the user's eye or virtual object represents a position at coordinate values (e.g., XYZ coordinate values) determined by an absolute coordinate system (world coordinate system) or coordinate values (e.g., xyz coordinate values or uvd coordinate values) determined by a local coordinate system with a predetermined point (e.g., glasses-free stereoscopic display 10) as a reference (origin point).

The content information acquisition unit 25 acquires information regarding the content displayed by the glasses-free stereoscopic display 10. In this embodiment, the content information acquisition unit 25 acquires the position or shape of a virtual object in the virtual space.

The position or shape of the virtual object acquired by the content information acquisition unit 25 is supplied to the determination unit 26 and the calculation unit 27.

The determination unit 26 determines whether or not the virtual object is a target of the switching of the display format. In this embodiment, the determination unit 26 determines whether or not the virtual object is located on the outside of the display region. Further, in this embodiment, the determination unit 26 performs various determinations on the virtual object located outside the display region and determines whether or not the virtual object is a target of the switching of the display format. Specific determination methods are classified into the following four patterns.

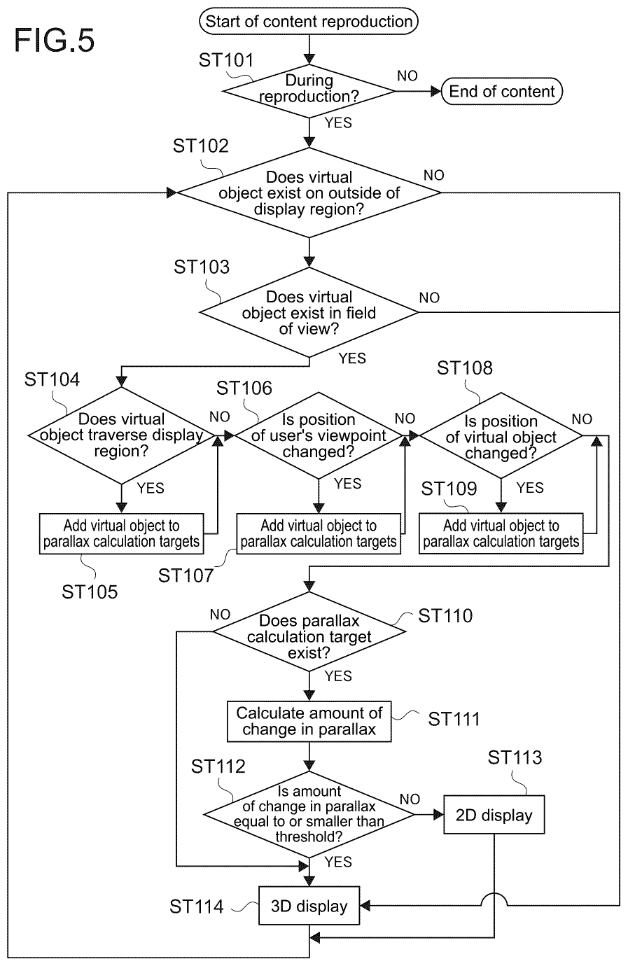

First pattern in a case where the virtual object traverses the display region from the inside to the outside of the display region or moves from the inside of the display region to the outside of the display region (Step 104 of FIG. 5).

Second pattern in a case where the position of a user's viewpoint with respect to the virtual object is changed (Step 106 of FIG. 5).

Third pattern in a case where the position of the virtual object on the outside of the display region is changed (Step 108 of FIG. 5).

Fourth pattern including at least two of the first pattern, the second pattern, or the third pattern described above. Note that, in this embodiment, traversing the display region from the inside to the outside of the display region means a state in which the virtual object is over the boundary between the inside of the display region and the outside of the display region, and a state in which the virtual object is stationary.

A determination result determined by the determination unit 26 is supplied to the calculation unit 27. Note that the determination by the determination unit 26 is performed on each virtual object in the content.

The calculation unit 27 calculates a user's parallax with respect to the virtual object serving as a target of the switching of the display format, which is determined by the determination unit 26. In this embodiment, the calculation unit 27 calculates the amount of change in user's parallax on the basis of the determination result of the virtual object (first to four patterns).

A calculation result calculated by the calculation unit 27 is supplied to the display controller 28.

The display controller 28 switches the display format of the virtual object on the basis of the viewpoint information of the user who visually recognizes the virtual space, and the position information of the virtual object displayed in the virtual space. In this embodiment, when the amount of change in parallax calculated by the calculation unit 27 exceeds a threshold, the display controller 28 changes the 3D-displayed virtual object into a 2D-displayed virtual object.

Further, in this embodiment, when the amount of change in parallax calculated by the calculation unit 27 does not exceed a threshold, the display controller 28 changes the 2D-displayed virtual object into a 3D-displayed virtual object.

Note that, in this embodiment, the inside of the display region 12 corresponds to a first region included in the virtual space.

Note that, in this embodiment, the outside of the display region corresponds to a second region included in the virtual space.

Note that, in this embodiment, the determination unit 26 corresponds to a determination unit that determines whether or not the virtual object is a target of the switching of the display format.

Note that, in this embodiment, the calculation unit 27 corresponds to a calculation unit that calculates a user's parallax with respect to the virtual object serving as a target of the switching of the display format.

Note that, in this embodiment, the display controller 28 corresponds to a display controller that switches the display format of the virtual object on the basis of the viewpoint information of the user who visually recognizes the virtual space, and the position information of the virtual object displayed in the virtual space.

FIG. 5 is a flowchart showing the display-format switching.

As shown in FIG. 5, when the content is being reproduced (YES in Step 101), the determination unit 26 determines whether or not a virtual object exists on the outside of the display region (Step 102).

If a virtual object exists on the outside of the display region (YES in Step 102), the determination unit 26 determines whether or not the virtual object exists in a user's field of view on the basis of the user's viewpoint information (Step 103).

If the virtual object exists in the user's field of view (YES in Step 103), the determination unit 26 determines whether or not the virtual object traverses the boundary in the display region on the basis of the position information of the virtual object (Step 104). If the virtual object traverses the boundary in the display region (YES in Step 104), that virtual object is added to parallax calculation targets (Step 105).

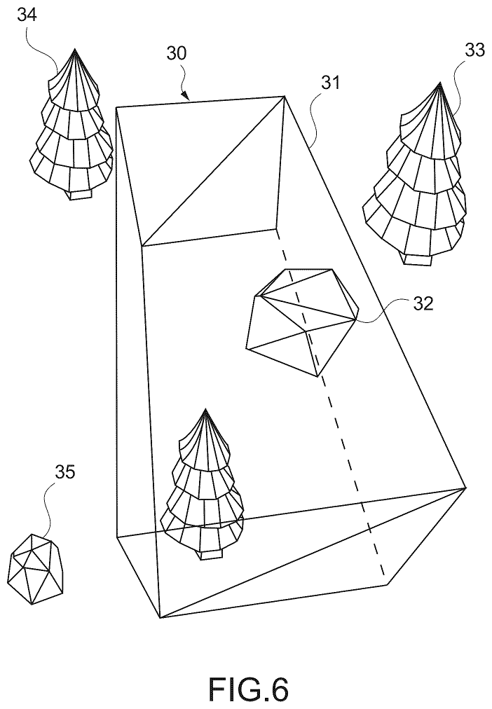

FIG. 6 is a schematic diagram showing a case where the virtual object traverses the display region.

As shown in FIG. 6, the virtual object (rock 32) traverses a boundary 31 of an inside of a display region 30. Further, in FIG. 6, a tree 33, a tree 34, and a rock 35 that are virtual objects exist on the outside of the display region, but those virtual objects are stationary, and the position of the user's viewpoint does not change. In other words, those virtual objects are not added to parallax calculation targets through the determinations in Step 104, Step 106, and Step 108.

The calculation unit 27 calculates the amount of change in parallax of the rock 32 added to the parallax calculation targets. When the amount of change in parallax is equal to or larger than a threshold, the display controller 28 switches the 3D-displayed rock 32 to be 2D-displayed. In other words, the display controller 28 changes a part of the rock 32 into 2D display, like an overhead view 19 shown in FIG. 3.

Further, the determination unit 26 determines whether or not the position of the user's viewpoint is changed on the basis of the user's viewpoint information (Step 106). If the position of the user's viewpoint is changed (YES in Step 106), that virtual object is added to parallax calculation targets (Step 107).

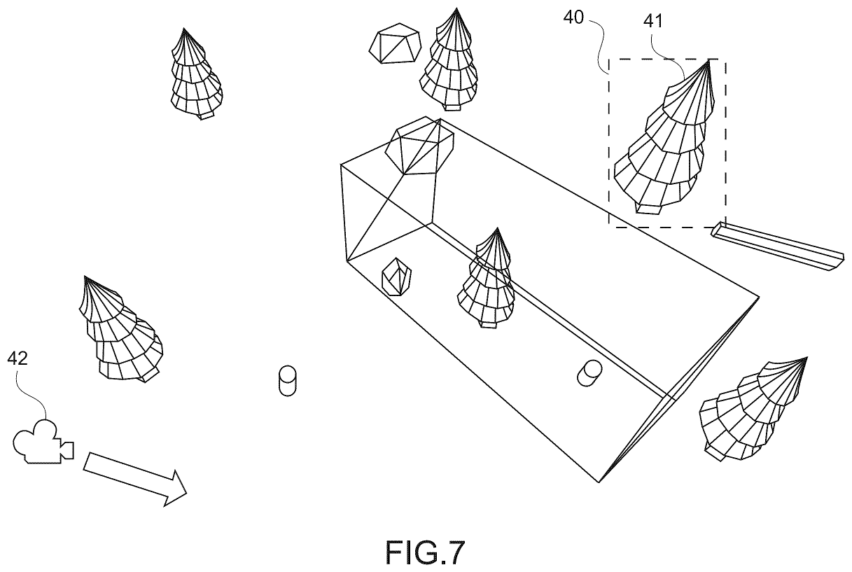

FIG. 7 is a schematic diagram showing a case where the position of the user's viewpoint is changed.

In FIG. 7, description will be given using an example of a virtual object (tree 41) surrounded by a dotted line 40. In other words, the tree 41 is a virtual object located on the outside of the display region and also located within the field of view of a user 42. As a matter of course, the determination in Step 106 may be performed on all the virtual objects located in the field of view of the user 42, or the determination may be performed only on a predetermined set number of virtual objects.

The calculation unit 27 calculates the amount of change in parallax of the user 42 at the tree 41. When the amount of change in parallax is equal to or larger than a threshold, the display controller 28 switches the 3D-displayed tree 41 to be 2D-displayed.

Further, the determination unit 26 determines whether or not the position of the virtual object is changed on the basis of the position information of the virtual object (Step 108). If the position of the virtual object is changed (YES in Step 108), that virtual object is added to parallax calculation targets (Step 109).

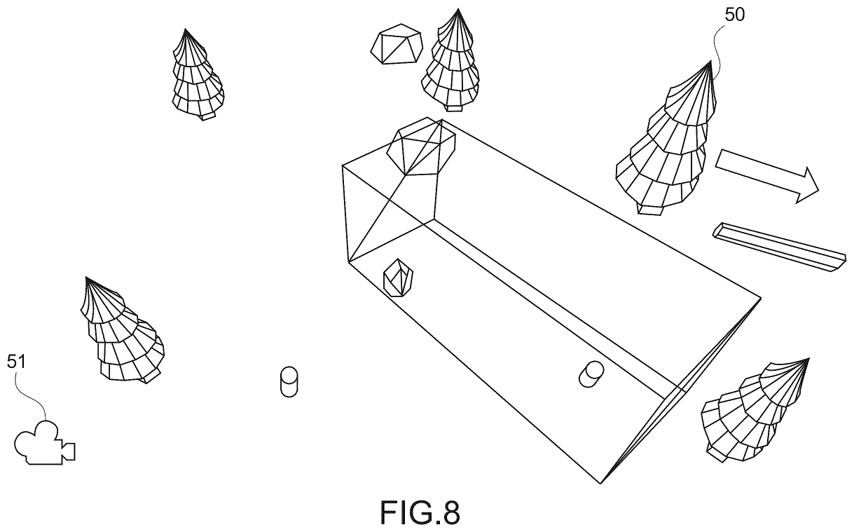

FIG. 8 is a schematic diagram showing a case where the position of the virtual object is changed.

In FIG. 8, it is assumed that a virtual object (tree 50) moves and the viewpoint of a user 51 is fixed. Further, it is assumed that the determinations in Step 104, Step 106, and Step 108 do not apply to virtual objects other than the tree 50.

The calculation unit 27 calculates the amount of change in parallax of the tree 50 added to parallax calculation targets. When the amount of change in parallax is equal to or larger than a threshold, the display controller 28 switches the 3D-displayed tree 50 to be 2D-displayed. Further, the display controller 28 displays a 2D image of the tree 50 corresponding to the position (angle) as viewed from the user 51.

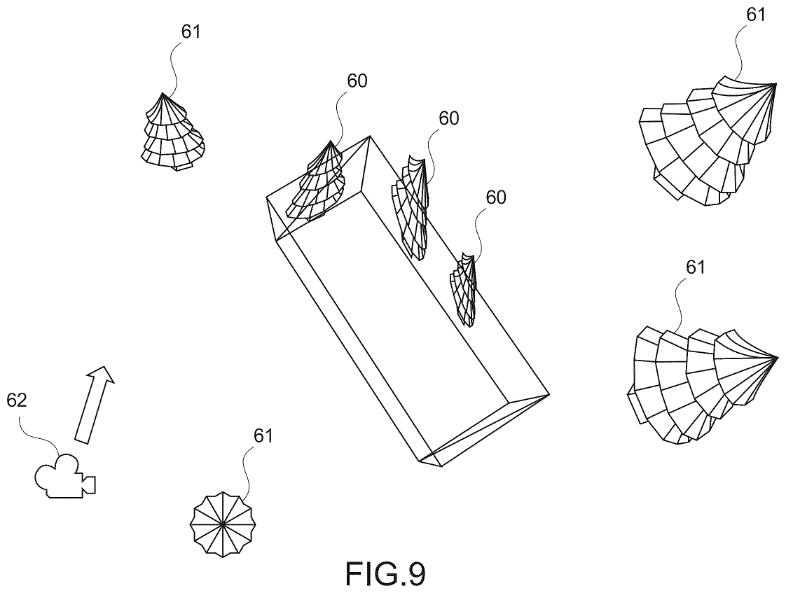

FIG. 9 is a schematic diagram showing a case of a plurality of parallax calculation targets.

FIG. 9 shows 2D-displayed virtual objects 60 and 3D-displayed virtual objects 61.

In this case, it is assumed that a user 62 moves.

Since the position of the user's viewpoint is changed, the determination unit 26 adds the virtual objects 60 and the virtual objects 61 to parallax calculation targets. The display controller 28 switches the display format depending on whether or not the amount of change in parallax of each virtual object exceeds a threshold. Further, the display controller 28 displays 2D images of the virtual objects corresponding to the positions at which the 2D-displayed virtual objects 60 and virtual objects newly 2D-displayed are viewed from the user 62.

If a parallax calculation target exists in the determinations in Steps 104, 106, and 108 (YES in Step 110), the calculation unit 27 calculates the amount of change in parallax (Step 111).

In this embodiment, the amount of change in parallax is represented by the following expression.

Amount of change in parallax angle Δd=|Current parallax angle d−Previous parallax angle d′|

Further, the method of calculating a parallax angle is represented by the following expression (Math. 1). Note that θ is 0<θ<π.

$$cos θ = \frac{a \cdot b}{\vert a \vert \cdot \vert b \vert} = \frac{{a}_{1} {b}_{1} + {a}_{2} {b}_{2} + {a}_{3} {b}_{3}}{\sqrt{{a}_{1}^{2} + {a}_{2}^{2} + {a}_{3}^{2}} \sqrt{{b}_{1}^{2} + {b}_{2}^{2} + {b}_{3}^{2}}} \qquad [ Math . 1 ]$$

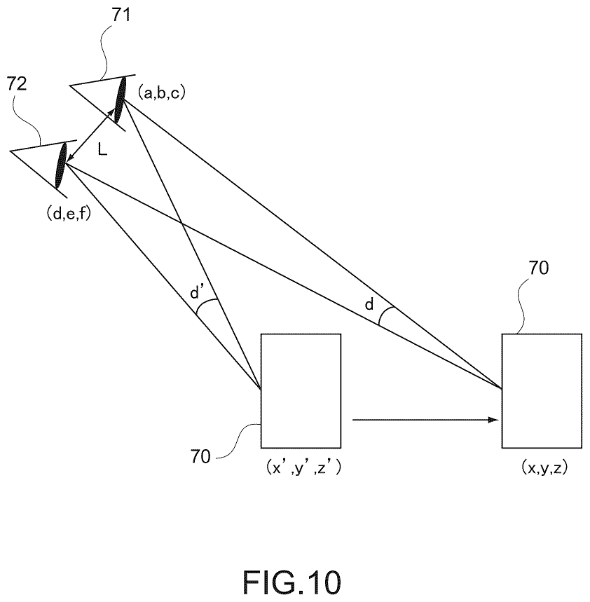

FIG. 10 is a schematic diagram showing a case where the position of the user's viewpoint is changed.

As shown in FIG. 10, it is assumed that a virtual object 70 moves from coordinates (x′, y′, z′) to coordinates (x, y, z). Further, the coordinates of a left eye 71 are denoted by (a, b, c), the coordinates of a right eye 72 are denoted by (d, e, f), and a distance between the left eye 71 and the right eye 72 is denoted by L.

The calculation unit 27 calculates a current parallax angle d and a previous parallax angle d′ from the state of FIG. 10 in accordance with the expression of Math. 1. If the amount of change in parallax, which is an absolute value of the amount of change in the calculated parallax angle, exceeds a threshold, the display controller 28 changes the virtual object 70 to be 2D-displayed.

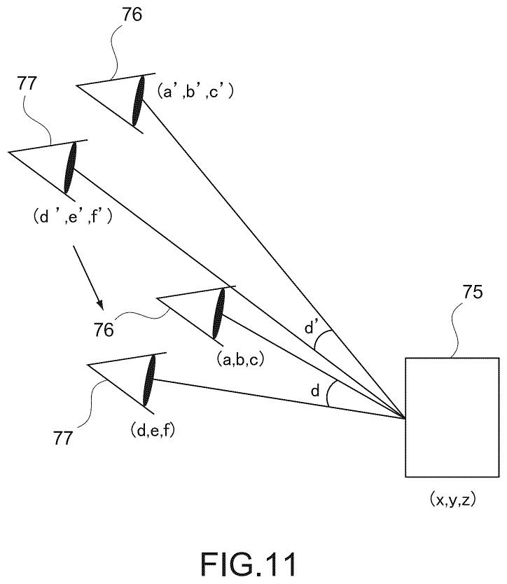

FIG. 11 is a schematic diagram showing a case where the position of the user's viewpoint is changed.

As shown in FIG. 11, it is assumed that a left eye 76 moves from coordinates (a′, b′, c′) to coordinates (a, b, c), and similarly a right eye 77 moves from coordinates (d′, e′, f′) to coordinates (d, e, f). Further, it is assumed that the coordinates of a virtual object 75 are denoted by (x, y, z).

The calculation unit 27 calculates a current parallax angle d and a previous parallax angle d′ from the state of FIG. 11 in accordance with the expression of Math. 1. If the amount of change in parallax, which is an absolute value of the amount of change in the calculated parallax angle, exceeds a threshold, the display controller 28 changes the virtual object 75 to be 2D-displayed.

If the amount of change in parallax calculated by the calculation unit 27 exceeds a threshold (YES in Step 112), the display controller 28 changes the virtual object 75 to be 2D-displayed (Step 113). In this case, the display controller 28 renders a 2D image of the virtual object 75 to serve as a background on the wall surface in accordance with the position of the user's viewpoint.

If the amount of change in parallax calculated by the calculation unit 27 is equal to or smaller than a threshold (NO in Step 112), the display controller 28 switches the 2D-displayed virtual object to be 3D-displayed, or maintains the display format of the 3D-displayed virtual object (Step 114).

Hereinabove, the information processing apparatus 20 according to this embodiment switches the display format of the virtual object on the basis of the viewpoint information of a user who visually recognizes the virtual space and the position information of the virtual object displayed in the virtual space. This makes it possible to achieve a high-quality viewing experience.

Conventionally, when content using a 3D CG object is displayed on a glasses-free stereoscopic display that is a glasses-free 3D display, the user takes a viewing posture for viewing the display from a higher point of view. So, if a space matched with the size of the display is defined, a stereoscopic effect is increased. However, if a virtual object is displayed outside the space, the space is not recognized, and the stereoscopic effect is degraded. Further, in the case of the glasses-free stereoscopic display, when a plurality of virtual objects is disposed in a depth direction and if the virtual objects with a large parallax are displayed instantaneously on the far side, fusion is difficult to occur and the virtual objects appear to be displayed doubly, which causes motion sickness of the user.

In the present technology, with the virtual objects displayed outside the display region as targets, if a parallax equal to or larger than any threshold occurs instantaneously in those virtual objects, a virtual object outside the display region is two-dimensionally rendered on the wall surface within the display region, so that the change in parallax is eliminated. At that time, if the virtual object outside the display region is displayed as an image of a certain fixed viewpoint on the wall surface, the inside and outside of the display region are seen in different ways, and thus the virtual object outside the display region is rendered in real time on the wall surface in accordance with the position of the user's viewpoint.

In other words, in the present technology, the display-format switching in which, regarding a virtual object located over the inside and outside of the display region, a portion inside the display region is 3D-displayed, a portion outside the display region is concealed by the wall surface, and an image projected onto the wall surface is presented to the user, and real-time 2D background generation according to the viewpoint position are performed.

### OTHER EMBODIMENTS

The present technology is not limited to the embodiment described above and can achieve various other embodiments.

In the embodiment described above, a virtual object located within the field of view is subjected to a determination and is added to parallax calculation targets. The present technology is not limited to this, and the determination and calculation of the amount of change in parallax angle may be performed on all of the displayed virtual objects.

In the embodiment described above, a parallax calculation target is added by the determinations in Step 104, Step 106, and Step 108. The present technology is not limited to this, and virtual objects may be added to parallax calculation targets by various methods. For example, the number of virtual objects added to parallax calculation targets may be set in accordance with the specifications such as an arithmetic capability or resolution of a display device such as the glasses-free stereoscopic display 10. Further, for example, when the number of virtual objects added to parallax calculation targets exceeds a certain number, the virtual objects may be 2D-displayed without calculating the amount of change in parallax.

In the embodiment described above, the glasses-free stereoscopic display 10 is used as a 3D display. The present technology is not limited to this, and a fully-immersive head mounted display (HMD) or a video see-through head mounted display may be used.

If a virtual object within a virtual space is displayed as a stereoscopic video by using a binocular parallax on a fully-immersive head mounted display, a parallax is calculated for a virtual object outside of a region having a radius of any distance centering on a viewpoint position, among virtual objects in the field of view (virtual objects displayed on HMD).

Note that the distance may be set by an application developer or may be set by a user (viewer) via a setting menu or the like.

Further, in a video see-through head mounted display, if a video input from a stereo camera installed on the front side is displayed on each of the left eye and the right eye to perform a stereoscopic parallax using a binocular parallax, a parallax is calculated for a virtual object outside of a region having a radius of any distance centering on a viewpoint position, among virtual objects in the field of view (virtual objects displayed on HMD).

Note that the distance may be set by an application developer or may be set by a user (viewer) via a setting menu or the like.

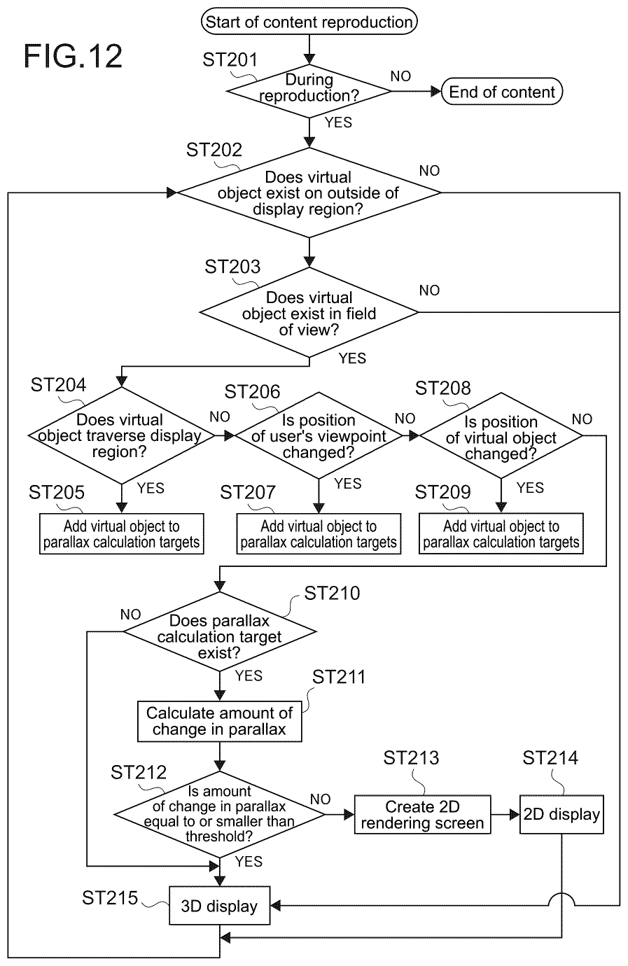

FIG. 12 is a flowchart of display-format switching in the fully-immersive head mounted display and the video see-through head mounted display.

Note that Step 201 to Step 212 shown in FIG. 12 are similar to Step 101 to Step 112 shown in FIG. 5, and thus description thereof will be omitted.

If the amount of change in parallax is equal to or smaller than a threshold (NO in Step 212), a 2D rendering screen (billboard) corresponding to the wall surface of the glasses-free stereoscopic display 10 is created (Step 213). In this embodiment, the display controller 28 creates a 2D rendering screen centering on an intersection between a line, which connects a viewpoint position and an virtual object serving as a parallax calculation target, and a boundary surface of the display region.

The display controller 28 projects a 2D-displayed virtual object, which is suitable for a manner that 3D display according to the viewpoint position is seen, in real time on the created 2D rendering screen (Step 214).

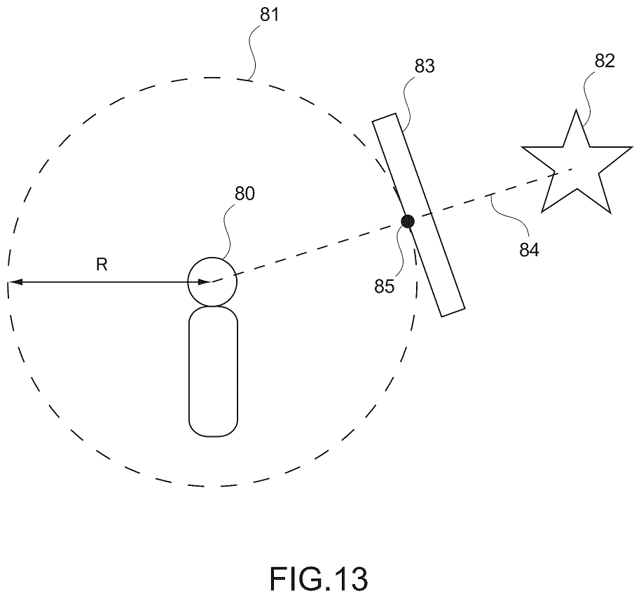

FIG. 13 is a schematic diagram showing a 2D display method for a virtual object in the fully-immersive head mounted display and the video see-through head mounted display.

As shown in FIG. 13, a user 80 wearing a fully-immersive head mounted display or a video see-through head mounted display, a display region 81, a virtual object 82, and a 2D rendering screen 83 are illustrated.

In FIG. 13, the display region 81 is set with any distance R as a radius centering on the user 80 (viewpoint position). Further, in this embodiment, the virtual object 82 is added to parallax calculation targets, and the amount of change in parallax is assumed to exceed a threshold.

In this case, as shown in Step 213 of FIG. 12, the display controller 28 creates the 2D rendering screen 83. In this embodiment, the 2D rendering screen 83 is created centering on an intersection 85 between a line 84, which connects the viewpoint position 80 and the virtual object 82, and a boundary surface of the display region 81.

The display controller 28 projects a 2D-displayed virtual object 82, which is suitable for a manner that 3D display according to the viewpoint position 80 is seen, in real time on the 2D rendering screen 83.

Note that the 2D rendering screen 83 is constantly directed to the viewpoint position 80 (user), constantly centering on the intersection 85 between the line 84, which connects the viewpoint position 80 and the virtual object 82, and the boundary surface of the display region 81. Further, the 2D rendering screen 83 may be transmissive.

The constituent elements such as the determination unit, the calculation unit, and the display controller, the flows of the display-format switching, and the like described with reference to the drawings are merely embodiments and can be discretionarily modified without departing from the gist of the present technology. In other words, any other constituent elements, algorithms, and the like for implementing the present technology may be adopted.

Further, the information processing apparatus, the information processing method, and the recording medium according to the present technology can be executed not only in a computer system including a single computer but also in a computer system in which a plurality of computers operates in conjunction with each other. Note that, in the present disclosure, a system means a collection of a plurality of constituent elements (apparatuses, modules (components), and the like), and whether or not all the constituent elements are in the same housing is not limited. Therefore, a plurality of apparatuses accommodated in separate housings and connected to each other through a network, and a single apparatus in which a plurality of modules is accommodated in a single housing are both the system.

The execution of the information processing apparatus, the information processing method, and the recording medium according to the present technology by a computer system include, for example, both a case where the determination of a virtual object, the calculation of a parallax angle, the display-format switching, and the like are executed by a single computer and a case where each process is executed by a different computer. Further, the execution of each process by a predetermined computer includes causing another computer to execute a part or all of the processes and acquiring a result thereof.

In other words, the information processing apparatus, the information processing method, and the recording medium according to the present technology are also applicable to a configuration of cloud computing in which a single function is shared and cooperatively processed by a plurality of apparatuses through a network.

Note that the effects described in the present disclosure are not limitative but are merely illustrative, and other effects may be provided. The description on the plurality of effects does not mean that those effects are not necessarily exerted at the same time. It means that at least any of the effects described above is obtained depending on conditions or the like, and as a matter of course, effects not described in the present disclosure may be exerted.

At least two of the characteristic portions according to each embodiment described above can be combined. In other words, the various characteristic portions described in each embodiment may be discretionarily combined without distinguishing between the embodiments.

Note that the present technology may also take the following configurations.

(1) An information processing apparatus, including
a display controller that switches a display format of a virtual object on the basis of viewpoint information of a user who visually recognizes a virtual space and position information of the virtual object displayed within the virtual space.
   (2) The information processing apparatus according to (1), in which
the virtual space includes a first region and a second region, and
the display controller switches the display format of the virtual object displayed in the first region.
   (3) The information processing apparatus according to (2), further including
a determination unit that determines whether or not the virtual object is a target of the switching of the display format.
   (4) The information processing apparatus according to (3), in which
the determination unit determines whether or not the virtual object exists in the first region on the basis of the position information, and if the virtual object exists in the first region, sets the virtual object as the target of the switching of the display format.
   (5) The information processing apparatus according to (3), in which
the determination unit determines whether or not the virtual object traverses a boundary of the first region on the basis of the position information, and if the virtual object traverses the first region, sets the virtual object as the target of the switching of the display format.
   (6) The information processing apparatus according to (3), in which
the determination unit determines whether or not the viewpoint information in the virtual object existing in the first region is changed on the basis of the viewpoint information, and if the viewpoint information is changed, sets the virtual object as the target of the switching of the display format.
   (7) The information processing apparatus according to (3), in which
the determination unit determines whether or not the position information of the virtual object existing in the first region is changed on the basis of the position information, and if the position information is changed, sets the virtual object as the target of the switching of the display format.
   (8) The information processing apparatus according to (3), in which
the determination unit determines whether or not the virtual object existing in the first region exists within a field of view of the user on the basis of the viewpoint information and the position information, and if the virtual object exists in the field of view of the user, sets the virtual object as the target of the switching of the display format.
   (9) The information processing apparatus according to (3), further including
a calculation unit that calculates a parallax of the user with respect to the virtual object set as the target of the switching of the display format.
   (10) The information processing apparatus according to (9), in which
the display controller switches the display format of the virtual object set as the target of the switching of the display format on the basis of a calculation result by the calculation unit.
   (11) The information processing apparatus according to (9), in which
the virtual object includes a stereoscopic image and a planar image, and
the switching of the display format includes at least one of switching of the virtual object from the stereoscopic image to the planar image or switching of the virtual object from the planar image to the stereoscopic image.
   (12) The information processing apparatus according to (11), in which
if an amount of change in parallax of the user with respect to the virtual object of the stereoscopic image exceeds a threshold, the virtual object being set as the target of the switching of the display format, the display controller switches the virtual object set as the target of the switching of the display format from the stereoscopic image to the planar image.
   (13) The information processing apparatus according to (11), in which
if an amount of change in parallax of the user with respect to the virtual object of the planar image exceeds a threshold, the virtual object being set as the target of the switching of the display format, the display controller maintains the display format of the virtual object set as the target of the switching of the display format.
   (14) The information processing apparatus according to (11), in which
if an amount of change in parallax of the user with respect to the virtual object of the planar image does not exceed a threshold, the virtual object being set as the target of the switching of the display format, the display controller switches the virtual object set as the target of the switching of the display format from the planar image to the stereoscopic image.
   (15) The information processing apparatus according to (11), in which
if an amount of change in parallax of the user with respect to the virtual object of the stereoscopic image does not exceed a threshold, the virtual object being set as the target of the switching of the display format, the display controller maintains the display format of the virtual object set as the target of the switching of the display format.
   (16) The information processing apparatus according to (9), in which
the determination unit determines whether or not an amount of change in parallax of the user with respect to the virtual object exceeds a threshold within a predetermined time, and if the amount of change in parallax of the user exceeds the threshold within the predetermined time, sets the virtual object as the target of the switching of the display format.
   (17) An information processing method, which is executed by a computer system, the method including
switching a display format of a virtual object on the basis of viewpoint information of a user who visually recognizes a virtual space and position information of the virtual object displayed within the virtual space.
   (18) A recording medium, on which a program is described, the program causing a computer system to execute
switching a display format of a virtual object on the basis of viewpoint information of a user who visually recognizes a virtual space and position information of the virtual object displayed within the virtual space.

### REFERENCE SIGNS LIST

12 inside of display region
13 outside of display region
20 information processing apparatus
26 determination unit
27 calculation unit
28 display controller
100 image display system

1. An information processing apparatus, comprising
a display controller that switches a display format of a virtual object on a basis of viewpoint information of a user who visually recognizes a virtual space and position information of the virtual object displayed within the virtual space.

2. The information processing apparatus according to claim 1, wherein
the virtual space includes a first region and a second region, and
the display controller switches the display format of the virtual object displayed in the first region.

3. The information processing apparatus according to claim 2, further comprising
a determination unit that determines whether or not the virtual object is a target of the switching of the display format.

4. The information processing apparatus according to claim 3, wherein
the determination unit determines whether or not the virtual object exists in the first region on a basis of the position information, and if the virtual object exists in the first region, sets the virtual object as the target of the switching of the display format.

5. The information processing apparatus according to claim 3, wherein
the determination unit determines whether or not the virtual object traverses a boundary of the first region on a basis of the position information, and if the virtual object traverses the first region, sets the virtual object as the target of the switching of the display format.

6. The information processing apparatus according to claim 3, wherein
the determination unit determines whether or not the viewpoint information in the virtual object existing in the first region is changed on a basis of the viewpoint information, and if the viewpoint information is changed, sets the virtual object as the target of the switching of the display format.

7. The information processing apparatus according to claim 3, wherein
the determination unit determines whether or not the position information of the virtual object existing in the first region is changed on a basis of the position information, and if the position information is changed, sets the virtual object as the target of the switching of the display format.

8. The information processing apparatus according to claim 3, wherein
the determination unit determines whether or not the virtual object existing in the first region exists within a field of view of the user on a basis of the viewpoint information and the position information, and if the virtual object exists in the field of view of the user, sets the virtual object as the target of the switching of the display format.

9. The information processing apparatus according to claim 3, further comprising
a calculation unit that calculates a parallax of the user with respect to the virtual object set as the target of the switching of the display format.

10. The information processing apparatus according to claim 9, wherein
the display controller switches the display format of the virtual object set as the target of the switching of the display format on a basis of a calculation result by the calculation unit.

11. The information processing apparatus according to claim 9, wherein
the virtual object includes a stereoscopic image and a planar image, and
the switching of the display format includes at least one of switching of the virtual object from the stereoscopic image to the planar image or switching of the virtual object from the planar image to the stereoscopic image.

12. The information processing apparatus according to claim 11, wherein
if an amount of change in parallax of the user with respect to the virtual object of the stereoscopic image exceeds a threshold, the virtual object being set as the target of the switching of the display format, the display controller switches the virtual object set as the target of the switching of the display format from the stereoscopic image to the planar image.

13. The information processing apparatus according to claim 11, wherein
if an amount of change in parallax of the user with respect to the virtual object of the planar image exceeds a threshold, the virtual object being set as the target of the switching of the display format, the display controller maintains the display format of the virtual object set as the target of the switching of the display format.

14. The information processing apparatus according to claim 11, wherein
if an amount of change in parallax of the user with respect to the virtual object of the planar image does not exceed a threshold, the virtual object being set as the target of the switching of the display format, the display controller switches the virtual object set as the target of the switching of the display format from the planar image to the stereoscopic image.

15. The information processing apparatus according to claim 11, wherein
if an amount of change in parallax of the user with respect to the virtual object of the stereoscopic image does not exceed a threshold, the virtual object being set as the target of the switching of the display format, the display controller maintains the display format of the virtual object set as the target of the switching of the display format.

16. The information processing apparatus according to claim 9, wherein
the determination unit determines whether or not an amount of change in parallax of the user with respect to the virtual object exceeds a threshold within a predetermined time, and if the amount of change in parallax of the user exceeds the threshold within the predetermined time, sets the virtual object as the target of the switching of the display format.

17. An information processing method, which is executed by a computer system, the method comprising
switching a display format of a virtual object on a basis of viewpoint information of a user who visually recognizes a virtual space and position information of the virtual object displayed within the virtual space.

18. A recording medium, on which a program is described, the program causing a computer system to execute
switching a display format of a virtual object on a basis of viewpoint information of a user who visually recognizes a virtual space and position information of the virtual object displayed within the virtual space.
